(19) United States
(12) Patent Application Publication
(10) Pub. No.: US 2017/0186203 A1
(43) Pub. Date: Jun. 29, 2017

(54) DISPLAY OF METEOROLOGICAL DATA IN AIRCRAFT

(71) Applicant: THALES, COURBEVOIE (FR)

(72) Inventors: François FOURNIER, TOULOUSE (FR); Frédéric PANCHOUT, TOULOUSE (FR); Mathieu CORNILLON, TOULOUSE (FR)

(21) Appl. No.: 15/390,075

(22) Filed: Dec. 23, 2016

(30) Foreign Application Priority Data
Dec. 29, 2015 (FR) 1502715

(51) Int. Cl. G06T 11/60; G01C 21/00; G06F 3/01; B64D 43/00; G06F 3/14; G06T 19/00

(52) U.S. Cl. CPC G06T 11/60; G06F 3/14; G06T 19/006; G06F 3/015; B64D 43/00; G01C 21/00; G06F 3/0482

(57) ABSTRACT

A method implemented by a computer for managing meteorological data for managing the flight of an aircraft, comprises the steps of receiving a cartographic background and selections of meteorological products; receiving meteorological data associated with the flight plan of the aircraft, according to a first space scale; determining one or more types of graphic symbols; as a function of a second space scale, determining one or more graphic declinations of the types of graphic symbols, the graphic superimpositions predefined; and displaying the cartographic background and the determined graphic declinations. Developments describe the management of the visual density of the display, the taking into account of the flight context and/or of the physiology of the pilot, the deactivation on request of the adjustments of the display. Software and system aspects (e.g. electronic flight bag, gaze monitoring) are also described.

### CROSS-REFERENCE TO RELATED APPLICATIONS

This application claims priority to foreign French patent application No. FR 1502715, filed on Dec. 29, 2015, the disclosure of which is incorporated by reference in its entirety.

### FIELD OF THE INVENTION

The invention relates to the technical field of meteorological data management in the context of navigation assistance for a transport means such as an aircraft.

### BACKGROUND

Meteorological information is essential for assisting in the navigation of an aircraft, which moves rapidly in varied and changing atmospheric conditions.

The meteorological information influences the operational preparation of the missions and the in-flight decisions. The decisive meteorological events notably comprise atmospheric movements (e.g. wind, storm, convection, turbulences, etc.), the hydrometeorological formations (e.g. rain, snow, fog, etc.), the presence of ice, the low or reduced visibility conditions, and the electrical phenomena (lightning).

The meteorological data are generally supplied in text and/or graphic form. With regard to the meteorological data of graphic type, they are generally displayed in the form of symbols, which are superimposed on one or more cartographic backgrounds or overlays.

Different display options are generally offered to the pilot to navigate efficiently within the meteorological data. These options notably comprise the possibility of selecting or filtering one or more criteria associated with a particular type of meteorological event, the possibility of selecting or of manipulating the display overlays, of choosing or of benefitting from the use of colour codes in order to indicate any risks or priorities, of managing the transparency of the different symbols displayed on the screen, etc.

Even so, these approaches present limitations.

The contemporary techniques for the representation and display of data sometimes culminate in a stacking of data which makes them illegible. When the pilot tries to view several types of meteorological data simultaneously, he or she may be drowned with information (symbols, lines, texts, colours) and consequently lose his/her capacity for analysis. Poor legibility and/or unsatisfactory options for navigation in the data sometimes very unfavourably impact on the decision-making by the pilot. The safety of the flight of the aircraft may be compromised, since the meteorological conditions form part of the most critical information for the flight management and the piloting of an aircraft.

There is an operational need for advanced systems and methods for managing meteorological data within the cockpits of aircraft.

### SUMMARY OF THE INVENTION

A method is disclosed that is implemented by meteorological information management computer for managing the flight of an aircraft, comprising the steps consisting in receiving a cartographic background and selections of meteorological products; receiving meteorological data associated with the flight plan of the aircraft, according to a first space scale; determining one or more types of graphic symbols; as a function of a second space scale, determining one or more graphic declinations of the types of graphic symbols, the graphic superimpositions being predefined; and displaying the cartographic background and the determined graphic declinations. Developments describe adjustments of the display notably as a function of the visual density of the display, the taking into account of the flight context and/or of the physiology of the pilot, the deactivation on request of the adjustments of the display. Software and system aspects (e.g. electronic flight bag, gaze monitoring) are also described.

Advantageously, an embodiment of the invention makes it possible to display several meteorological products simultaneously, by making it possible to distinguish the different products from one another.

Advantageously, an embodiment of the invention makes it possible to create or maintain a link between a meteorological product and its criticality.

Advantageously, the invention improves the decision-making of the pilot, by making it possible notably to improve the legibility of the information displayed, and in a measurable manner.

Advantageously, the examples described simplify the human-machine interactions and in particular relieve the pilot of tedious procedures for accessing the meteorological information, sometimes repetitive and often complex, by the same token improving his or her concentration capacity for the actual piloting. Improving the human-machine interaction model, the visual field of the pilot can be used best and more intensively, making it possible to maintain a high level of attention or best make use thereof. The cognitive effort to be provided is optimized, or, to be more precise, partially reallocated to cognitive tasks that are more useful with regard to the flight management and piloting objective. In other words, the technical effects linked to certain aspects of the invention correspond to a reduction of the cognitive load of the user of the human-machine interface.

Advantageously, an advantageous embodiment of the symbology makes it possible to reduce the training or learning costs, by benefiting from the legacy and from the synthesis of standard and normative symbols.

Advantageously, the invention makes it possible to assist the pilot in order to predetermine contextually useful information.

Advantageously, the invention makes it possible to simultaneously restore to the screen the aspects of “criticality” (qualitative importance) and of the “severity” (quantitative importance) of the meteorological events. In the field of dependability or of quality management, the “criticality” is defined as the product of the probability of occurrence of an incident by the gravity or the severity of its consequences (“criticality=probability×gravity”). The criticality of a meteorological event depends equally on the frequency or on its probability of occurrence, on its gravity and generally aims to assess and prevent the risks of undesirable chain reaction (systemic risks).

Advantageously, the invention can be applied in the avionics or aeronautical context (including remote drone piloting) but also in motor vehicle, rail or sea transport context.

### BRIEF DESCRIPTION OF THE DRAWINGS

Other features and advantages of the invention will become apparent with the aid of the description which follows and the figures of the appended drawings in which:

FIG. 1 illustrates the overall technical environment of the invention;

FIG. 2 schematically illustrates the structure and the functions of a flight management system of known FMS type;

FIG. 3 represents an example of a type of symbol according to an embodiment of the invention;

FIG. 4 shows examples of graphic declinations of a given type of symbol;

FIGS. 5 and 6 illustrate examples of adjustment of the display according to an embodiment of the invention;

FIG. 7 shows examples of steps of the method according to the invention;

FIG. 8 shows an example of selection of a plurality of meteorological products;

FIG. 9 illustrates system aspects of the measurement of the visual density;

FIG. 10 illustrates different aspects concerning the human-machine interfaces HMI.

### DETAILED DESCRIPTION

The invention can be implemented on one or more electronic flight bags EFB and/or on one or more screens of the flight management systems FMS and/or on one or more screens of the cockpit display system CDS. The display can be “distributed” over these different display screens.

An electronic flight bag, acronym EFB, designates embedded electronic libraries. An EFB is an electronic device used by the navigating personnel (for example pilots, maintenance, cabin crew, etc.). An EFB can supply flight information to the crew, assisting the latter in performing tasks (with increasingly less paper). One or more applications make it possible to manage information for flight management tasks. These general-purpose computer platforms are intended to reduce or replace the reference material in paper form, often found in the hand baggage of the “Pilot Flight Bag” and the handling of which can be tedious, notably in critical flight phases. The reference paper documentation generally comprises the piloting manuals, the various navigation maps and the ground operation manuals. These documentations are advantageously dematerialized in an EFB. Furthermore, an EFB can host software applications specially designed to automate the operations carried out manually in normal time, such as, for example, the take-off performance computations (computation of limit velocities, etc.). There are different classes of EFB hardware. The class 1 EFBs are portable electronic devices (PED), which are not normally used during take-off and other critical phases. This class of device does not require any particular certification or authorization administrative process. The class 2 EFB devices are normally arranged in the cockpit, e.g. mounted in a position where they are used during all the flight phases. This class of devices requires prior authorization for use. The class 1 and 2 devices are considered as portable electronic devices. Class 3 fixed installations, such as computer mounts or fixed docking stations installed in the cockpit of aircraft generally require the approval of and certification from the regulator.

Like any display device, the quantity of information to be displayed on an EFB can come up against limits (notably with regard to the display of weather data) and it is advantageous to implement methods optimizing the display of data.

In addition, or as an alternative, to the display on one or more EFBs, data can be displayed on one or more screens of the FMS displayed in the cockpit of the aircraft. The acronym FMS corresponds to “Flight Management System” and designates the aircraft flight management systems. In the preparation for a flight or upon a diversion, the crew proceeds to input different information relating to the progress of the flight, typically by using an aircraft flight management system FMS. An FMS comprises input means and display means, as well as computation means. An operator, for example the pilot or the co-pilot, can input, via the input means, information such as RTA (Required Time of Arrival), or “waypoints”. associated with waypoints, that is to say points vertical to which the aircraft must pass. These elements are known in the prior art through the international standard ARINC 424. The computation means notably make it possible to compute, from the flight plan comprising the list of waypoints, the trajectory of the aircraft, as a function of the geometry between the waypoints and/or of the altitude and velocity conditions.

Hereinafter in the document, the acronym FMD is used to denote the display of the FMS present in the cockpit, generally arranged head-down (at the lower level of the instrument panel).

The acronym ND is used to denote the graphic display of the FMS present in the cockpit, generally arranged head mean, i.e. in front of the face. This display is defined by a reference point (centred or at the bottom of the display) and a range, defining the size of the display area.

The acronym HMI corresponds to the human-machine interface. The input of the information, and the display of the information input or computed by the display means, constitute such a human-machine interface. Generally, the HMI means make it possible to input and consult flight plan information. The embodiments described hereinbelow detail advanced HMI systems.

Different embodiments are described hereinbelow.

A method is disclosed that is implemented by meteorological information management computer for managing the flight of an aircraft, comprising the steps consisting in receiving a cartographic background out of several predefined cartographic backgrounds; receiving a plurality of selections of meteorological products; receiving meteorological data associated with the flight plan of the aircraft, according to a first space scale; determining one or more types of graphic symbols as a function of the meteorological products selected and of the meteorological data received; and, as a function of a second space scale, determining one or more graphic declinations of the types of graphic symbols, the graphic superimpositions of said declinations of the types of symbols being predefined; displaying the cartographic background and the determined graphic declinations.

The graphic superimpositions of the declinations of the types of symbols are defined combinatorily: the method selects the best graphic option out of the possible options, primarily in terms of legibility.

A space scale corresponds to the dimensions of a cell of space (generally in km² or square nautical miles), corresponding for example to the format of the meteorological data of regulatory nature. The invention allows for “enlargements” or “zooms (in)”, respectively “reductions” or “simplifications” or “zooms out”, with or without modification of the visual density. In an embodiment, the content is adapted to the display scale selected.

In an embodiment, the pilot manually selects the display scale (e.g. the zoom or enlargement level): the second space scale is received from the pilot and/or from a configuration file (involvement of a third-party machine).

In a development, the method further comprises a step consisting in measuring the visual density of the display comprising the cartographic background and the graphic symbols and a step consisting in adjusting said display as a function of the measured visual density.

In an embodiment, the display scale is determined automatically. In an embodiment, the appropriate display scale is determined as a function of the legibility (psychometric concept) adapted to the visual density measurement displayed.

The display density can notably be determined by an intrinsic measurement (e.g. number of pixels per unit of surface area) and/or by an extrinsic measurement (e.g. external image acquisition means).

The step of measurement of the visual density and the step of adjustment are independent in time: the steps can be performed in succession or in parallel, i.e. with or without correction of a first non-optimized display (which can moreover be hidden from the pilot). In an embodiment, the optimizations are performed upstream (the measurement of the visual density is intrinsic) and the final result is displayed. In an embodiment, the extrinsic visual density measurement is ascertained, then corrected.

In a development, the method further comprises a step consisting in determining the current flight context of the aircraft and the plurality of selections of meteorological products being determined as a function of said current flight context of the aircraft.

In a development, the graphic superimpositions of the declinations of the types of symbols are associated with predefined visual rankings and the step consisting in determining one or more graphic declinations of the types of graphic symbols comprising the step consisting in maximizing the sum of the rankings associated with the superimpositions of the determined graphic declinations.

The capacity (or property) for superimposition of the different symbols that can be invoked can be quantified (objectively by measurement of the visual density or subjectively by preliminary evaluations). The “superimposability” of the symbols is therefore configurable. The monitoring of the ranking therefore makes it possible for example to modulate the rendering of the display.

In a development, the step consisting in adjusting the display comprises a step consisting in modifying the type and/or the number of graphic symbols.

The declinations of the types of symbols according to the invention can be superimposed by construction. In a development, quantitative information is encoded graphically (e.g. thickness of the lines that make up the symbol or its declination, colour, etc.). Quantitative information should be understood to mean the frequency or the quantity of the meteorological product concerned for example.

In a development, the step consisting in adjusting the display comprises the steps consisting in eliminating and/or in superimposing one or more types of graphic declinations of the symbols displayed.

In a development, the method further comprises a step consisting in receiving at least one value associated with the physiological state of the pilot of the aircraft and in determining one or more graphic declinations of the types of graphic symbols and/or adjusting the display as a function of the physiological state of the pilot.

In a development, the adjustment of the display is deactivated on request.

The automatic zoom and/or the manipulations on the graphic symbols can be cancelled or deactivated or reversed at the request of the pilot and/or on request from an avionics system (so-called disengageable mode, useful for example in cases of emergency for removing the non-essential graphic overlays).

A computer program product is disclosed, comprising code instructions making it possible to perform the steps of the method when said program is run on a computer.

A system is disclosed comprising means for implementing the steps of the method.

In a development, the system comprises at least one display screen chosen from a flight screen PFD and/or a navigation screen ND/VD and/or a multifunction screen MFD and/or one or more display screens of an electronic flight bag.

In a development, the system comprises means for acquiring images of one or more display screens.

In a development, the system comprises (in addition or instead) means for monitoring the physiology of the pilot of the aircraft.

In a development, the system comprises (in addition or instead) a device for monitoring the gaze of the pilot.

In a development, the system comprises (in addition or instead) augmented reality and/or virtual reality means.

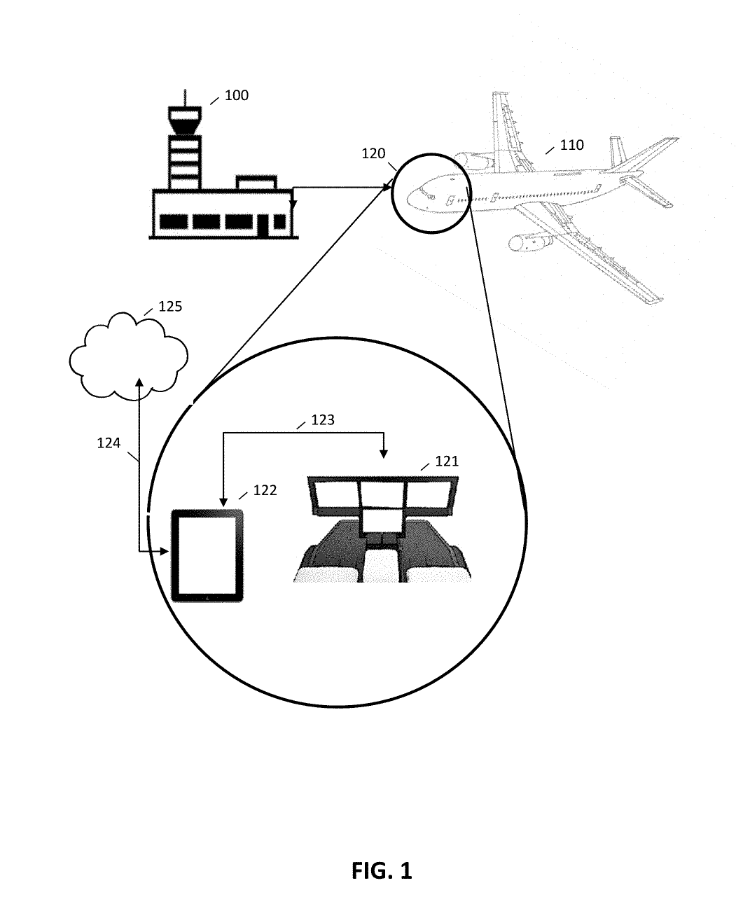

FIG. 1 illustrates the overall technical environment of the invention. Avionics equipment items or airport means 100 (for example a control tower linked with the air traffic control systems) are in communication with an aircraft 110. An aircraft is a transport means capable of moving in the earth's atmosphere. For example, an aircraft can be an aeroplane or a helicopter (or even a drone). The aircraft comprises a piloting cabin or a cockpit 120. In the cockpit, there are piloting equipment items 121 (called avionics equipment items), comprising, for example, one or more onboard computers (computation, memory and data storage means), including an FMS, means for displaying or viewing and inputting data, communication means, and (possibly) haptic feedback means and a taxiing computer. A touch tablet or an EFB 122 can be located onboard, in portable form or incorporated in the cockpit. Said EFB can interact (bilateral communication 123) with the avionics equipment items 121. The EFB can also be in communication 124 with external computer resources, accessible via the network (for example cloud computing 125). In particular, the computations can be performed locally on the EFB or partially or totally in the computation means accessible via the network. The onboard equipment items 121 are generally certified and regulated whereas the EFB 122 and the connected computing means 125 are generally not certified (or are to a lesser extent). This architecture makes it possible to inject flexibility on the side of the EFB 122 while ensuring a controlled security on the embedded avionics 121 side.

Among the onboard equipment items there are different screens. The ND screens (graphic display associated with the FMS) are generally arranged in the primary field of view, at “head mean”, whereas the FMDs are positioned “head down”. All of the information entered or computed by the FMS is grouped together on so-called FMD pages. The existing systems make it possible to navigate from page to page, but the size of the screens and the need to not place too much information on a page for its legibility make it impossible to apprehend all of the current and future situation of the flight in summary fashion. The crews of modern aeroplanes in the cockpit generally consist of two people, distributed on either side of the cockpit: a “pilot” side and a “co-pilot” side. Business aeroplanes sometimes have only a pilot, and certain older aeroplanes or military transport planes have a crew of three people. Everyone views on his or her HMI the pages that are of interest to him or her. Several out of the hundred possible are generally displayed permanently during the execution of the mission: the “flight plan” page first of all which contains the route information followed by the aeroplane (list of the next waypoints with their associated predictions in terms of distance, time, altitude, velocity, fuel, wind). The route is divided into segments, legs and procedures, which are themselves made up of points and comprises a “performance” page which contains the parameters useful for guiding the aeroplane over the short term (velocity to be followed, altitude ceilings, next changes of altitude). There are also a multitude of other pages available onboard (the lateral and vertical revision pages, the information pages, pages specific to certain aircraft), or generally a hundred or so pages.

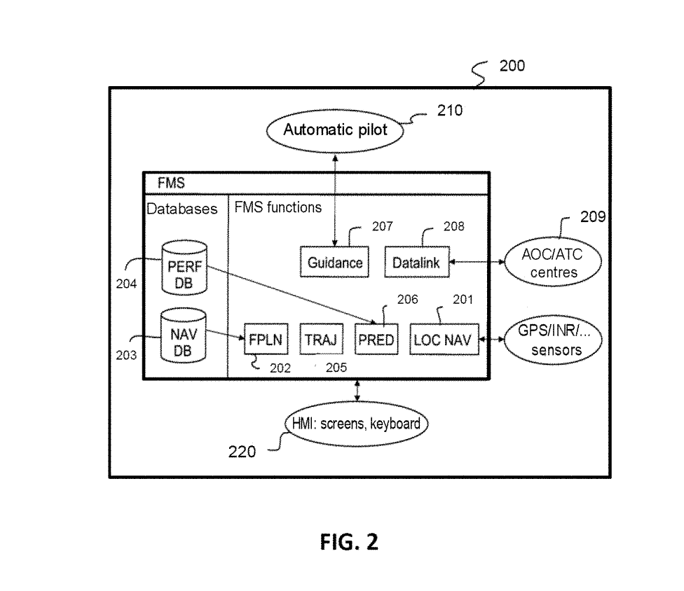

FIG. 2 schematically illustrates the structure and the functions of a flight management system of known FMS type. A system of FMS type 200 arranged in the cockpit 120 and the avionics means 121 have a human-machine interface 220 comprising input means, for example formed by a keyboard, and display means, for example formed by a display screen, or else simply a touch display screen, and at least the following functions:

Navigation (LOCNAV) 201, to perform the optimal location of the aircraft as a function of the global positioning means such as the GNSS satellite global positioning (e.g. GPS, GALILEO, GLONASS, etc.), the VHF radio navigation beacons, the inertial units. This module communicates with the above-mentioned geolocation devices;

Flight plan (FPLN) 202, for inputting geographical elements forming the “skeleton” of the route to be followed, such as the points imposed by the departure and arrival procedures, the waypoints, the air corridors, commonly called “airways”. An FMS generally hosts several flight plans (the so-called “active” flight plan over which the aeroplane is guided, the “temporary” flight plan making it possible to make modifications without activating the guidance over this flight plan and the “inactive” working flight plans (called “secondary”));

Navigation database (NAVDB) 203, for constructing geographic routes and procedures from data included in the bases relating to the points, beacons, interception or altitude legs, etc.;

Performance database, (PERFDB) 204, containing the aerodynamic and engine parameters of the aircraft;

Lateral trajectory (TRAJ) 205, for constructing a continuous trajectory from the points of the flight plan, observing the performance levels of the aircraft and the confinement constraints (RNAV for Area Navigation or RNP for Required Navigation Performance);

Predictions (PRED) 206, for constructing an optimized vertical profile on the lateral and vertical trajectory and giving the estimations of distance, time, altitude, velocity, fuel and wind notably on each point, at each change of piloting parameter and at destination, which will be displayed to the crew;

Guidance (GUID) 207, for guiding, in the lateral and vertical planes, the aircraft on its three-dimensional trajectory, while optimizing its velocity, using information computed by the Predictions function 206. In an aircraft equipped with an automatic piloting device 210, the latter can exchange information with the guidance module 207;

Digital datalink (DATALINK) 208 for exchanging flight information between the Flight plan/Prediction functions and the control centres or other aircrafts 209;

one or more HMI screens 220.

All of the information entered or computed by the FMS is grouped together on display screens (FMD, NTD and PFD pages, HUD or similar). In airline aeroplanes of Airbus A320 or A380 type, the trajectory of the FMS is displayed at head mean, on a display screen called Navigation Display (ND). The “Navigation display” offers a geographic view of the situation of the aircraft, with the display of a cartographic background (the exact nature, appearance and content of which can vary), sometimes with the flight plan of the aeroplane, the characteristic points of the mission (equal time point, end of climb, start of descent, etc.), the surrounding traffic, the weather in its various aspects such as the areas of rain and storms, icy conditions, etc., generally originating from the embedded meteorological radar (e.g. echoes of reflectivity which make it possible to detect rainy or stormy areas). On the aeroplanes of the Airbus A320, A330, A340, Boeing B737/747 generation, there is no interactivity with the flight plan display screen. The flight plan is constructed from an alphanumeric keyboard on an interface called MCDU (Multi Purpose Control Display). The flight plan is constructed by inputting the list of the “waypoints” represented in tabular form. It is possible to input a certain number of information items on these “waypoints”, via the keyboard, such as the constraints (velocity, altitude) that the aeroplane must observe in passing the waypoints. This solution presents a number of defects. It does not make it possible to deform the trajectory directly, it has to be done by a successive input of “waypoints”, either existing in the navigation databases (NAVDB standardized onboard in the AEEC ARINC 424 format), or created by the crew via its MCDU (by inputting coordinates for example). This method is tedious and inaccurate given the size of the current display screens and their resolution. For each modification (for example a deformation of the trajectory to avoid a dangerous weather hazard, which is moving), it may be necessary to re-input a succession of waypoints outside of the area concerned.

From the flight plan defined by the pilot (list of “waypoints”), the lateral trajectory is computed as a function of the geometry between the waypoints (commonly called leg) and/or the altitude and velocity conditions (which are used to compute the turn radius). On this lateral trajectory, the FMS optimizes a vertical trajectory (in terms of altitude and velocity), involving any altitude, velocity, time constraints. All of the information entered or computed by the FMS is grouped together on display screens (MFD pages, NTD and PFD displays, HUD or similar). The HMI part 220 of FIG. 2 therefore comprises a) the HMI component of the FMS which structures the data for sending to the display screens (called CDS for Cockpit Display system) and b) the CDS itself, representing the screen and its graphic driver software, which handles the display of the drawing of the trajectory and which also comprises the computer drivers that make it possible to identify the movements of the finger (in the case of a touch interface) or of the pointing device.

All of the information entered or computed by the FMS is grouped together on “pages” (graphically displayed on one or more screens of the FMS). The existing systems (called “glass cockpits”) make it possible to navigate from page to page, but the size of the screens and the need to not overload the pages (in order to preserve their legibility) do not make it possible to apprehend the current and future situation of the flight in summary fashion. Thus, the search for a particular element of the flight plan can take the pilot a long time, above all if he or she has to navigate within numerous pages (long flight plan). In effect, the different FMS and screen technologies currently used make it possible to display only between 6 and 20 lines and between 4 and 6 columns.

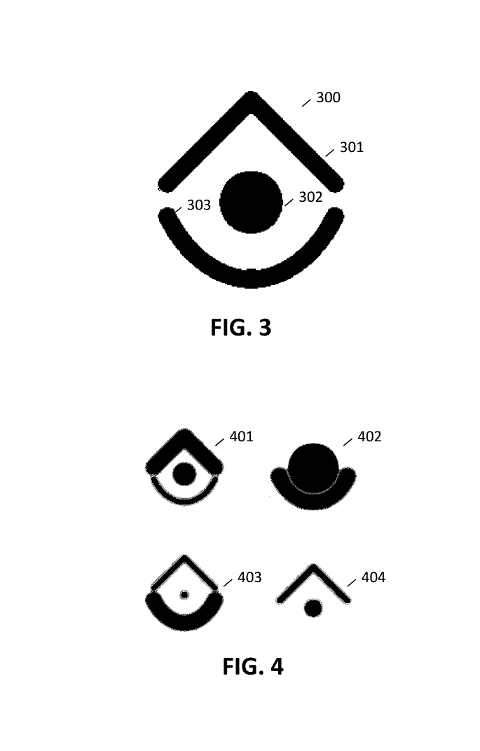

FIG. 3 shows an example of a type of symbol according to an embodiment of the invention.

The symbols according to the invention exhibit a property of “superimposability” constructed in principle or afterwards. This property of superimposition is configurable and denotes the capacity of a graphic symbol to be graphically superimposed on several other predefined graphic symbols. In an embodiment of the invention, a graphic symbol is associated with a plurality of forms or of graphic declinations, each of these forms being configured to optimize the graphic legibility of the information encoded in said symbol when the graphic symbol is displayed on or under other graphic elements.

The example 300 shown in FIG. 3 comprises a sub-part 301 representing the clear sky turbulence meteorological conditions (“clear air turbulence”), a sub-part 302 associated with the convection zone meteorological conditions (“convection”) and a sub-part 303 associated with the icing meteorological conditions (“icing”).

In a unified manner, the symbol 300 concatenates three types of meteorological information in one and the same symbol, while not requiring any significant learning on the part of the pilot.

According to an aspect of the invention, standard icons (standardized- or de facto standards) are merged or unified, whereas they were previously used separately. This shrewd merging avoids a significant learning period on the part of the pilot. For example, with respect to “Clear Air Turbulence”, “Icing” and “Convection”, the unified geometrical symbol 300 combines the standard symbols of the three types of events in one and the same pattern, allowing for a rapid recognition of the three components by the pilot.

The superimposition principle can be generalized.

In a development, the symbology according to the invention can restore quantitative aspects, which are notably contextual (that is to say translate or reflect data or values, as filtered and/or selected in a database). In other words, the technical result of technical operations conducted on technical data restored by a particular graphic encoding.

Different types of symbols or meteorological products can be manipulated by the method according to the invention, notably of “surface” type (e.g. the products are represented by graphic surfaces such as polygons, notably for ice and convection, cloudiness, ash clouds, SIGMET, etc.), of “linear” type (e.g. products represented linearly, the manipulation of which in changes of scale and/or display adjustments is more difficult compared to surfaces, for example the lines of jet streams, the hot/cold front festooned lines), of “spot” type (e.g. products represented in spot fashion such as lightning strikes, the state of the airports according to METAR/TAF, PIREP, etc.) and of “matrix” type (e.g. products made up of a matrix of local measurements such as a display grid of the winds/temperatures at different altitudes).

FIG. 4 shows examples of graphic declinations of a given type of symbol (in this case 300).

For example, the variant embodiment 401 reflects significant turbulence meteorological conditions and/or conversely, lesser or negligible icing conditions. The variant embodiment 402 shows the absence of turbulent conditions, but stresses significant convection and icing conditions (e.g. above one or more predefined thresholds). The variant embodiment 403 illustrates a situation in which the icing conditions are predominant. The situation 404 illustrates a situation in which the icing conditions are non-existent (e.g. below a predefined threshold). The colour variants are not represented but increase the combinatorial possibilities.

Advantageously, the coding or encoding of the information in one or more symbols according to the invention can be read by an automated system (because it is known to it, i.e. “machine-readable content”). In other words, the symbols according to the invention can be considered as codes, legible both by the human operator and by a machine (e.g. a computer).

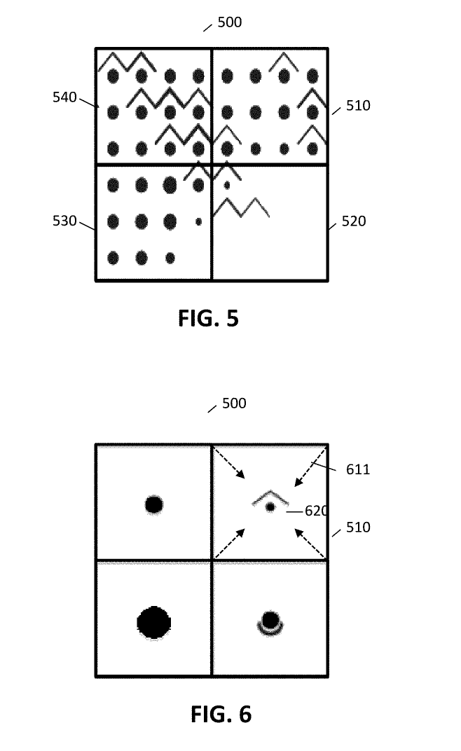

FIGS. 5 and 6 illustrate examples of specific steps of the method according to the invention. In a development, the method according to the invention can in fact comprise one or more steps notably consisting in adjusting the visual density of the symbols displayed on the display screens in the cockpit of the aircraft. Whether the visual density measurement is intrinsic (that is to say by measurements performed in the display system) or else extrinsic (that is to say produced by measurements performed by the third-party system), the quantity and/or quality of the symbols displayed can be modified. For example, based on the level of zoom, that is to say on the level of enlargement of the underlying mapping selected by the pilot, the final graphic representation may be more or less well spaced or, on the contrary, detailed. By considering space scales or pitches or computation cells, the method can comprise a step consisting in determining one or more majority meteorological conditions in each computation cell.

FIG. 5 shows an extract from a cartographic background on which a plurality of symbols according to the invention are superimposed. The figure shows four cells (50 km² surface areas) 510, 520, 530 and 540.

FIG. 6 shows an example of adjustment of the display (for example as a function of the display density measurement and/or of the flight context). In each of the cells, there are different meteorological conditions. In the example, since the visual density of the cell 510 is too high in a particular flight context, a computation 611 determines the association of the cell 510 with just one and the same symbol 620. Different computation modalities are possible for performing such reductions. The mean meteorological conditions current on the cell can be determined and restored. Alternatively, filters can be applied and lead to restoring only anomalies and/or critical events in the cell concerned. The determination of the resultant symbol can also be a function of criteria or parameters comprising the flight context, the physiological state of the pilot at a given instant, the criticality and/or the severity of one or more meteorological events, etc.

In an embodiment of the invention, the display is at least partially conditioned on the measurement of the value of a physiological parameter of the pilot.

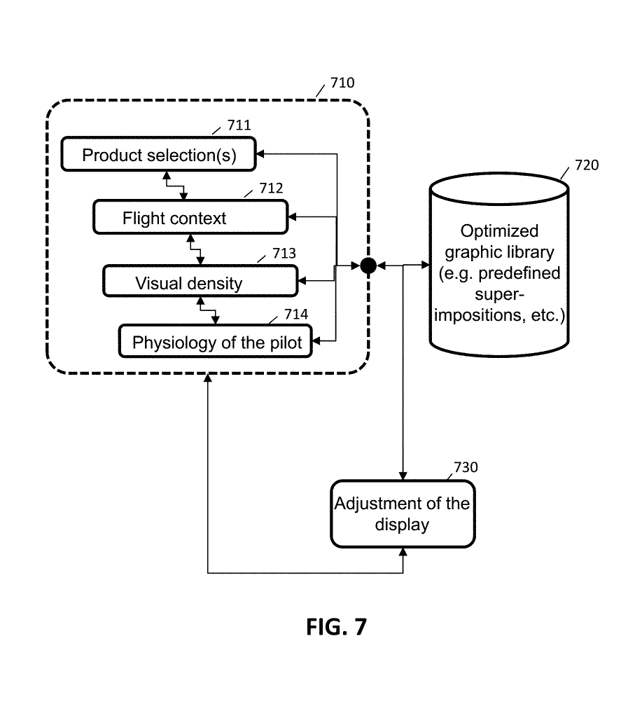

FIG. 7 shows examples of steps of the method according to the invention.

Based on different parameters 710 (selections of meteorological products 711, flight context 712, visual density 713, physiology 714), symbols from a database 720 optimized beforehand are displayed and the display is adjusted 730.

One and the same symbol can be displayed differently according to the display context and/or the display density. The display context can notably be determined as a function of the flight context (e.g. take off, climb, cruising, etc.).

For example, the different meteorological symbols can be placed in the area of presence of the meteorological products with a size adapted to the zoom of the mapping, with a scale linked to the frequency and/or quantity of the product and a colour matched to their severity. In an embodiment, the front lines and the wind and temperature symbols are displayed in a standard manner and are superimposed on the Clear Air Turbulence, Icing and convection symbols. The front lines can notably be transparent and show the other meteorological products behind. The symbols concerning wind can be thin enough to make it possible to see the products in the background. The temperatures can be displayed textually and the display can be adapted to the current level of enlargement (“zoom”) in order to make it possible to view meteorological products in the background. In certain embodiments, the clouds can be represented in the form of more or less dense white areas, superimposed on the map background, with, in the background, all the other meteorological products which remain visible. The cloud outlines can be identified by a continuous line.

Certain symbols can be associated with higher display priorities, not only in terms of occurrence (if an event occurs, it is immediately restored to the screen without the use of a time delay) but also of depth of computation (for example, in an embodiment, the meteorological event associated with lightning can be manipulated as a priority, the lightning being generally deemed more critical, and the corresponding symbol will always be displayed in the foreground if necessary). The lightning will be superimposed on all the products in an embodiment of the invention.

Based on the level of enlargement (respectively of reduction) of the display (“zoom” and “unzoom”), some display areas can be enlarged and/or the distance between two symbols can be increased.

In an embodiment, at any moment and for each product, the pilot can select a symbol or a representation of a meteorological product to access the detailed information of the selected area (long press, short press accompanied by a predefined command, etc).

Different levels of graphic superimposition can be predefined, i.e. defined previously. In an embodiment, several types of symbols are predefined and each symbol has different graphic declinations, each declination being associated with a different superimposition property with the different declinations of the different types of symbols. The display is adjusted in as much as a higher level of superimposition “adds” information by superimposing symbols but also simplifies the display thereof for certain aspects.

Different adjustments are possible. In an embodiment, the level of zoom or enlargement is increased (or reduced). In other embodiments, by image analysis (performed at fixed regular intervals or continually in the case of video capture), the information density is estimated according to the different sub-parts of images and display adjustments are determined dynamically. For example, in the case where a display screen becomes too “cluttered” (quantity of text or of graphic symbols in excess of one or more predefined thresholds), the lower priority information is “reduced” or “condensed” or “summarized” in the form of markers or symbols that can be selected according to various modalities (placement of interactive markers on or along a graphic representation of the flight of the aircraft). Conversely, if the density of information displayed permits it, information reduced or condensed or summarized, for example previously, is expanded or detailed or extended or enlarged.

In an embodiment of the invention, the “visual density” is kept substantially constant. The flight phase or context can modulate this visual density (for example, on landing or in the critical phases of the flight, the density of information is reduced).

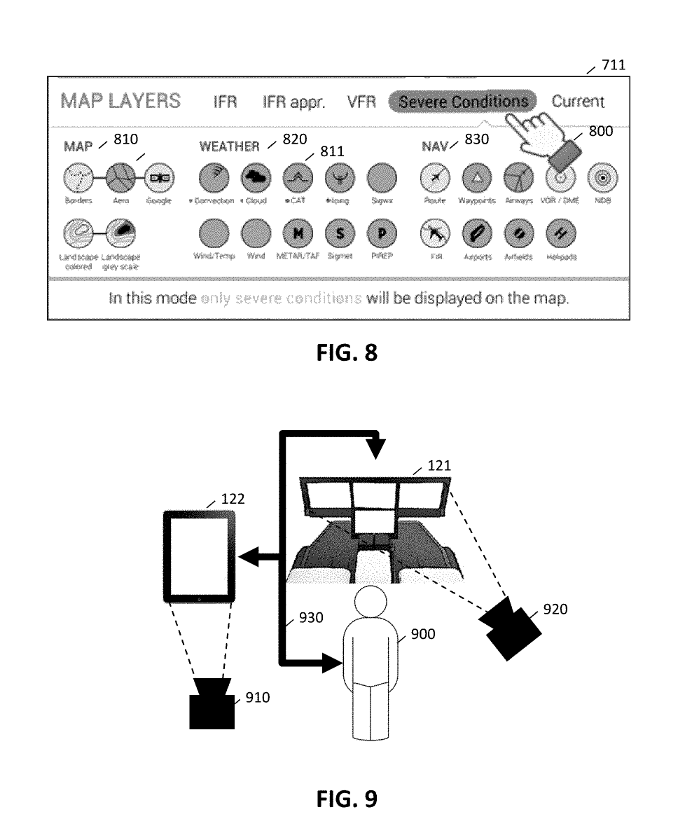

FIG. 8 shows an example of selection of a plurality of meteorological products.

The pilot (or a computerized system) selects a cartographic background out of several cartographic backgrounds (i.e. different display overlays). Similarly, one or more display criteria make it possible to configure the display of the meteorological information available.

The pilot can notably configure the display of the meteorological data by selecting types of information to be displayed (the pilot can select all, or none, or on a case by case basis). In an embodiment, the pilot can select the “severe condition” parameter or factor (severe meteorological conditions, i.e. potentially dangerous for the aircraft), which can then lead to the display of all the “severe conditions” of all the types of meteorological data in the form (for example) of areas indicated as stormy, for example symbols (lightning points) or figures (weather at the airport). Advantageously, the existence of information of “severe condition” type can be displayed on the screen (for example a symbol like a colour pad) and can indicate what type of meteorological data has “severe conditions”. In other words, the existence of a “severe condition” can be notified graphically.

In an embodiment, different intensities of the atmospheric phenomena can be selected for display. For example, the pilot can filter, i.e. select, the level of severity to be displayed (for example “moderate and severe”, “severe”).

More generally, concerning meteorological information, manual and/or automatic selections can be made. Automatically, the onboard instrumentation (sensors, flap status, embedded computing, etc.) and/or the manual declarations of the pilot can determine the current flight context of the aircraft (e.g. take off, climb, cruising, approach, descent, etc.). In a development, the display is adjusted as a function of the current flight context. It is in fact advantageous to show certain meteorological information at certain points/instants (for example the wind on the ground or take off, the presence of jet stream in cruising, etc.). The contextualization of the meteorological information is advantageous.

In certain embodiments of the invention, the method comprises logical methods or steps making it possible to determine the “flight context” or “current flight context” of the aircraft.

The flight context at a given moment incorporates all the actions taken by the pilots (and notably the actual piloting set points) and the influence of the outside environment on the aircraft.

A “flight context” for example comprises a situation out of the predefined or pre-categorized situations associated with data such as the position, the flight phase, the waypoints, the current procedure (and others). For example, the aircraft can be in approach phase for landing, in take-off phase, in cruising phase but also in level ascending, level descending, etc. (a variety of situations can be predefined). Moreover, the current “flight context” can be associated with a multitude of descriptive attributes or parameters (current meteorological state, traffic state, status of the pilot comprising for example a level of stress as measured by sensors, etc).

A flight context can therefore also comprise data, for example filtered by priority and/or based on flight phase data, meteorological problems, avionics parameters, ATC negotiations, anomalies linked with the flight status, problems linked to the traffic and/or relief. Examples of “flight context” comprise, for example, contexts such as “cruising speed/no turbulences/pilot stress nominal” or even “landing phase/turbulences/pilot stress intense”. These contexts can be structured according to various models (e.g. organized hierarchically for example in tree form or according to various dependencies, including graphs). Categories of contexts can be defined, so as to summarize the needs in terms of human-machine interaction (e.g. minimum or maximum interaction delay, minimum and maximum quantity of words, etc). Specific rules may also remain in certain contexts, notably emergencies or critical situations. The categories of contexts can be static or dynamic (e.g. configurable).

The method can be implemented in a system comprising means for determining a flight context of the aircraft, said determination means comprising in particular software rules, which manipulate values such as measured by physical measurement means. In other words, the means for determining the “flight context” comprise system or “hardware” or physical/tangible means and/or logic means (e.g. logical rules, for example predefined). For example, the physical means comprise the avionics instrumentation proper (radars, probes, etc.) which make it possible to establish factual measurements characterizing the flight. The logic rules represent all the information processing operations that make it possible to interpret (e.g. contextualize) the factual measurements. Some values may correspond to several contexts and by correlation and/or computation and/or simulation, it is possible to decide between candidate “contexts”, by means of these logic rules. A variety of technologies makes it possible to implement these logic rules (formal logic, fuzzy logic, intuitional logic, etc.).

Based on the context as determined by the method, the method according to the invention may “sensorially” restore information whose selection is chosen with care or “intelligence”. Sensory restoration should be understood to mean that the information can be restored by different cognitive modes (vision, hearing, haptic feedback, i.e. touch/vibration, etc.) and/or according to a combination of these modes. A single cognitive sense can be stressed (for example via just the graphic display of the information), but according to some embodiments, a multimodal restoration can be performed (graphic display and, simultaneously or asynchronously, transmission of vibration via suitable devices, for example to the wrist of the pilot). Advantageously, the multimodal restoration allows for a certain robustness of communication of the flight set points to the pilots. For example, if it is likely that a piece of information has not been taken into account, reminders using a different combination of the cognitive modes can be applied.

FIG. 9 illustrates system aspects of the measurement of the visual density.

The display density can notably be determined by an intrinsic measurement (e.g. number of pixels per unit of surface area, as indicated by the internal graphics processor for example) and/or by an extrinsic measurement (e.g. a video camera 910 or image acquisition means 920 capturing the final rendering of the representation of the data on the EFB 122 and/or the FMS screens 121, for example by measuring this number of pixels per unit of surface area).

According to the embodiments, the “visual density” or “display density” can be measured as a number of pixels switched on or active per square centimetre, and/or as a number of alphanumeric characters per unit of surface area and/or as a number of predefined geometrical patterns per unit of surface area. The visual density can also be defined, at least partially, according to physiological criteria (model of pilot reading speed, etc.).

From a system viewpoint, image acquisition means (for example a camera or a video camera arranged in the cockpit) make it possible to capture at least a part of all of the visual information displayed to the pilot (advantageously, this video feedback will be placed on a head-up visor, smartglasses or any other equipment worn by the pilot, so as to capture the subjective view of the pilot).

In an embodiment, the method comprises the steps consisting in receiving a capture of the display screen by a third-party image acquisition system and in determining a map of visual density of said capture.

The determination of the visual density can be done by extraction of data from images (“scraping”). Data that can be extracted from the image or video acquisitions include data such as text (by OCR, Optical Character Recognition), numerical values, cursor or dial positions, etc. Extractions of data or information from audio streams are also possible (separately or in combination).

A “scraping” operation denotes an operation of recovery or of capture of information on a digital object, said recovery or capture not being intrinsically provided by the digital object. For example, this recovery of information can comprise the acquisition of one or more images followed by the recognition of characters in the captured images.

In an embodiment, a shot is acquired, analyzed, blocked out, and the captured information is extracted from the image. The prior knowledge of the captured image type can allow for a specific recognition (e.g. view angle). In a variant, the shot will be of video type 920 (that is to say acquisition of a succession of fixed images, the large number of images captured notably allowing for an optimization of the capture of information and/or a robustness to the movements of the user carrying the image acquisition means. According to another embodiment, the image acquisition means are mounted in a fixed manner in the cockpit of the aircraft. By this means, the capture or recovery of information can be performed continuously. According to another embodiment, the image acquisition means can correspond to cameras or video cameras fixed onto virtual or augmented reality headsets.

In a development of the invention, the method further comprises a step consisting in receiving 930 at least one value associated with the physiological state of the pilot 900 of the aircraft and in adjusting the display as a function of the physiological state of the pilot as measured. The determination of the physiological state of the pilot comprises direct and/or indirect measurements. The direct measurements notably comprise one or more direct measurements of the heart rate and/or ECG (electrocardiogram) and/or EEG (electroencephalogram) and/or perspiration and/or the breathing rate of the pilot. The indirect measurements comprise estimations of the excitation or fatigue or stress of the pilot, which states can be correlated to the flight phases.

Different HMI management models are possible. The contextual and physiological management of the display can be performed on the basis of rules.

The reconfiguration of the display can be conditional, e.g. the rules can comprise tests and/or checks. The rules can take parameters of avionics type and/or non-avionics type. For example, the different phases of the flight plan (take-off, cruising or landing), including according to a finer breakdown, can be associated with different configurations/reconfiguration rules. For example, the display needs on take-off are not the same as those during cruising and the density of the display can be reconfigured accordingly. The tests can also take into account cognitive and/or biological data (for example via the measurement of the cognitive load of the pilot and leading in return to an adaptation of the display, a monitoring of the biological parameters of the pilot, e.g. heart rate and perspiration from which stress level estimations can be inferred can result in adapting or reconfiguring the display in a certain way, for example by increasing the density or by lightening the screens, etc.).

In an embodiment, the reconfiguration of the screen is “disengageable”, i.e. the pilot can decide to cancel all the adaptations of the current display and revert rapidly to the native display mode without said reconfiguration. The reconfiguration mode can for example be exited by voice command (passphrase) or via an actuator (deactivation button).

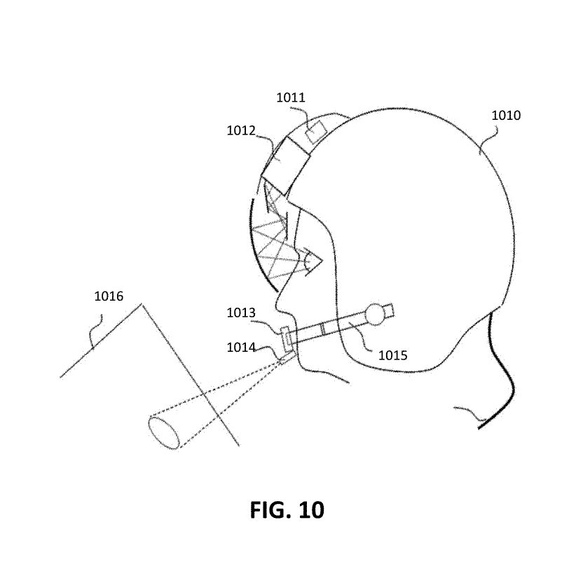

FIG. 10 illustrates different aspects relating to the human-machine interfaces HMI which can be set up to implement the method according to the invention. In addition to—or instead of—screens of the onboard FMS and/or EFB computer, additional HMI means can be used. Generally, the FMS avionics systems (which are systems certified by the airline regulator and which can exhibit certain limitations in terms of display and/or ergonomy) can advantageously be complemented by non-avionics means, in particular advanced HMIs.

The representation of at least a part of the flight of the aircraft can be produced in two dimensions (e.g. display screen) but also in three dimensions (e.g. virtual reality or 3D display on screen). In 3D embodiments, the markers can be selectable areas of the space (selectable by different means, e.g. by virtual reality interfaces, glove, trackball or by other devices). The three-dimensional display can complement the two-dimensional display within the cockpit (e.g. semi-transparent virtual reality headset, augmented reality headset, etc.). If necessary, various forms of representation of the flight are possible, the additional depth dimension being able to be allocated to a time dimension (e.g. flight duration) and/or space dimension (e.g. distance between the different waypoints, physical representation of the trajectory of the aircraft in space, etc.). The same variants or variants similar to the 2D case can be implemented: management of the density of information, placement of markers, appearances and disappearances of symbols, highlighting of the events during the flight, etc.

In particular, the human-machine interfaces can make use of virtual and/or augmented reality headsets. FIG. 10 shows an opaque virtual reality headset 1010 (or a semi-transparent augmented reality headset or a headset with configurable transparency) worn by the pilot. The individual display headset 1010 can be a virtual reality (VR) headset, or an augmented reality (AR) headset or a head-up display, etc. The headset can therefore be a “head-mounted display”, a “wearable computer”, “glasses” or a video headset. The headset can comprise computation and communication means 1011, projection means 1012, audio acquisition means 1013 and video projection and/or video acquisition means 1014. In this way, the pilot can—for example by means of voice commands—configure the display of the flight plan in three dimensions (3D). The information displayed in the headset 1010 can be entirely virtual (displayed in the individual headset), entirely real (for example projected onto the flat surfaces available in the real environment of the cockpit) or a combination of the two (partly a virtual display superimposed on or merged with the reality and partly a real display via projectors).

Reproduction of information can notably be performed in a multimodal manner (e.g. haptic feedback, visual and/or auditory and/or tactile and/or vibratory reproduction).

The display can also be characterized by the application of predefined placement rules and display rules. For example, the human-machine interfaces (or the information) can be “distributed” (segmented into distinct portions, possibly partially redundant, then allocated) between the different virtual screens (e.g. 1010) and/or real screens (e.g. FMS, TAXI).

The various steps of the method can be implemented wholly or partly on the FMS and/or on one or more EFBs. In a particular embodiment, all of the information is displayed on the screens of just the FMS. In another embodiment, the information associated with the steps of the method is displayed on just the embedded EFBs. Finally, in another embodiment, the screens of the FMS and of an EFB can be used jointly, for example by “distributing” the information over the different screens of the different devices. A spatial distribution of the information performed in an appropriate manner can contribute to reducing the cognitive load of the pilot and consequently improve the decision-making and increase the flight safety.

The invention can also be implemented on or for different display screens, notably the electronic flight bags EFB, ANF (Airport Navigation Function), etc. In a development, the system comprises augmented reality and/or virtual reality means.

The display means can comprise, in addition to the screens of the FMS, an opaque virtual reality headset and/or a semi-transparent augmented reality headset or a headset with configurable transparency, projectors (pico-projectors for example, or video projectors for projecting the simulation scenes) or even a combination of such devices. The headset can therefore be a “head-mounted display”, a “wearable computer”, “glasses”, a video headset, etc. The information displayed can be entirely virtual (displayed in the individual headset), entirely real (for example projected onto the flat surfaces available in the real environment of the cockpit) or a combination of the two (partly a virtual display superimposed on or merged with the reality and partly a real display via projectors).

The AR means comprise in particular systems of HUD (“Head Up Display”) type and the VR means comprise in particular systems of EVS (“Enhanced Vision System”) or SVS (“Synthetic Vision System”) type.

The visual information can be distributed or allocated or projected or masked as a function of the immersive visual context of the pilot. This “distribution” can lead to the environment of the pilot being considered in an opportunistic manner by considering all the surfaces available so as to add (superimpose, overlay) virtual information, chosen appropriately in their nature (what to display), temporality (when to display, at what frequency) and placement (priority of the displays, stability of the placements, etc.). At one extreme, all of the placements used little or faintly in the environment of the user can be exploited to increase the density of the display of information. Even more, by projection of image masks superimposed on the real objects, the display can “erase” one or more control instruments present physically in the cockpit (joysticks, knobs, actuators), the geometry of which is known and stable to further increase the surfaces that can be addressed. The real environment of the cockpit can therefore be transformed into as many “potential” screens, even into a single unified screen.

The display can be “distributed” within the cockpit: the various screens present in the cockpit, depending on whether they are accessible or not, can be made to contribute in allocating the information which has to be displayed. Moreover, augmented and/or virtual reality means can increase the display surfaces. The augmentation of the available display surface does not render the control of the display density permitted by the invention null and void. On the contrary, the (contextual) reconfiguration of the display agglomerating this increase in the addressable display surface and the control of the visual density (e.g. contextual concentration or density increase) make it possible to significantly enhance the human-machine interaction.

In an embodiment, the reconfiguration of the screen according to the invention can be “disengaged”, i.e. the pilot can decide to cancel or deactivate all the modifications of the current display to revert quickly to the “nominal” display, i.e. native mode without the display modifications. The reconfiguration mode can for example be exited by voice command (passphrase) or via an actuator (deactivation button). Different events can trigger this precipitated exit from the graphic reconfigurations in progress (for example “sequencing” of a waypoint, a change of flight phase, the detection of a major anomaly such as an engine failure, a depressurization, etc.).

In a development, the system comprises exclusively interface means of touch type. In a particular embodiment of the invention, the cockpit is all touch, i.e. exclusively made up of HMI interfaces of touch type. The methods and systems according to the invention in fact allow for “all touch” embodiments, that is to say according to a human-machine interaction environment entirely made up of touch screens, with no tangible actuator but, advantageously, entirely reconfigurable.

In a development, the system further comprises means for acquiring images of the cockpit (e.g. interpretation or reinjection of data by OCR and/or image recognition—by “scraping”—, camera mounted on a headset worn by the pilot or camera fixed at the rear of the cockpit) and/or a gaze tracking device.

The present invention can be implemented from hardware and/or software elements. It can be available as computer program product on a computer-readable medium. The medium can be electronic, magnetic, optical or electromagnetic. Some computing means or resources can be distributed (“cloud computing”).

1. A method implemented by a computer for managing meteorological data for managing the flight of an aircraft, comprising the steps of:
receiving a cartographic background out of several predefined cartographic backgrounds;
receiving a plurality of selections of meteorological products;
receiving meteorological data associated with the flight plan of the aircraft, according to a first space scale;
determining one or more types of graphic symbols as a function of the meteorological products selected and of the meteorological data received;
as a function of a second space scale, determining one or more graphic declinations of the types of graphic symbols, the graphic superimpositions of said declinations of the types of symbols being predefined;
displaying the cartographic background and the determined graphic declinations.

2. The method according to claim 1, further comprising a step of measuring the visual density of the display comprising the cartographic background and the graphic symbols and a step consisting in adjusting said display as a function of the visual density measured.

3. The method according to claim 1, further comprising a step of determining the current flight context of the aircraft and the plurality of selections of meteorological products being determined as a function of said current flight context of the aircraft.

4. The method according to claim 1, the graphic superimpositions of the declinations of the types of symbols being associated with predefined visual rankings and the step of determining one or more graphic declinations of the types of graphic symbols comprising the step of maximizing the sum of the rankings associated with the superimpositions of the determined graphic declinations.

5. The method according to claim 2, the step of adjusting the display comprising a step consisting in modifying the type and/or the number of graphic symbols.

6. The method according to claim 2, the step of adjusting the display comprising the steps consisting in eliminating and/or in superimposing one or more types or graphic declinations of the symbols displayed.

7. The method according to claim 1, further comprising a step of receiving at least one value associated with the physiological state of the pilot of the aircraft and determining one or more graphic declinations of the types of graphic symbols and/or adjusting the display as a function of the physiological state of the pilot.

8. The method according to claim 2, the adjustment of the display being deactivated on request.

9. A computer program product, comprising code instructions making it possible to perform the steps of the method according to claim 1, when said program is run on a computer.

10. A system comprising means for implementing the steps of the method according to claim 1, comprising at least one display screen chosen from a flight screen PFD and/or a navigation screen ND/VD and/or a multifunction screen MFD and/or one or more display screens of an electronic flight bag.

11. The system according to claim 10, comprising means for acquiring images of one or more display screens.

12. The system according to claim 10, comprising means for monitoring the physiology of the pilot of the aircraft.

13. The system according to claim 10, comprising a device for tracking the gaze of the pilot.

14. The system according to claim 10, comprising augmented reality and/or virtual reality means.
